(19) United States
(12) Patent Application Publication
(10) Pub. No.: US 2016/0016118 A1
(43) Pub. Date: Jan. 21, 2016

(54) MEMBRANE FOR DISTILLATION INCLUDING NANOSTRUCTURES, METHODS OF MAKING MEMBRANES, AND METHODS OF DESALINATION AND SEPARATION

(71) Applicant: KING ABDULLAH UNIVERSITY OF SCIENCE AND TECHNOLOGY, Thuwal (SA)

(72) Inventors: Zhiping Lai, Thuwal (SA); Kuo-Wei Huang, Thuwal (SA); Wei Chen, Thuwal (SA)

(21) Appl. No.: 14/772,936

(22) PCT Filed: Mar. 5, 2014
(86) PCT No.: PCT/IB2014/000597

§ 371 Date: Sep. 4, 2015

Related U.S. Application Data
(60) Provisional application No. 61/772,570, filed on Mar. 5, 2013.

(51) Int. Cl. B01D 61/36; C02F 1/44; B01D 67/00; B01D 69/02; B01D 71/02

(52) U.S. Cl. CPC B01D 61/364; B01D 69/02; B01D 71/021; B01D 67/0072; C02F 1/447; B01D 2323/40; B01D 2325/06; B01D 2325/38; C02F 2103/08

(57) ABSTRACT

In accordance with the purpose(s) of the present disclosure, as embodied and broadly described herein, embodiments of the present disclosure provide membranes, methods of making the membrane, systems including the membrane, methods of separation, methods of desalination, and the like.

### CROSS-REFERENCE TO RELATED APPLICATIONS

This application is the National Stage of International Application No. PCT/IB2014/000597, filed 5 Mar. 2014, which claims the benefit of and priority to U.S. Provisional Application No. 61/772,570, filed on Mar. 5, 2013, having the title “MEMBRANES INCLUDING NANOTUBES, METHODS OF MAKING MEMBRANES AND METHODS OF DESALINATION AND SEPARATION”, the contents of all of which are incorporated by reference as if fully set forth herein.

### BACKGROUND

Technical advances in desalination over the last thirty years have resulted in significant reductions in energy consumption and correspondingly, the overall desalination cost.^{[1,2]} Now desalination is considered a feasible technology to mitigate the shortage of portable water all over the world. Table 1 lists the up-to-date energy consumption and the overall desalination costs of the four most important desalination technologies that have been commercialized in large scale, i.e., multi-stage flashing (MSF), multi-effect distillation (MED), reverse osmosis (RO), and mechanical vapor compression (MVC).^{[3,4]} However, for arid areas like the Middle East, water demand is increasing dramatically not only for portable usage, but also for industrial expansion and agriculture development due to a fast-growing population. The cost of existing technologies is still a big obstacle. Substantially reducing the cost of desalination is highly desired, but is unlikely from existing technologies since they have reached almost their technique limits.^{[1]} An innovative technology coupled with inexpensive sustainable energy resources is desired to reduce desalination cost.

TABLE 1
Energy consumption and water cost of large scale commercial
seawater desalination processes^{[3,4]}

| | MSF | MED | RO | MVC |
|---|---|---|---|---|
| Energy cost (kWh/m³) | 10-16 | 5.5-9 | 2-4 | 7 |
| Total cost (U.S. $) | 0.8-1.5 | 0.7-1.2 | 0.5-1.2 | 0.7 |

One promising technology is membrane distillation (MD).^{[5]} The MD process uses a microporous hydrophobic membrane to prevent the passage of liquid by surface tension force, but not the passage of vapor. Hence, when the membrane contacts a hot salinated stream from one side and a cold stream from the other side, vapor will transport from the hot stream to the cold stream due to different vapor pressure across the membrane. Fresh water can thus be obtained on the cold stream side. In principle, MD is a thermally driven process, with the large vapor chamber used in conventional thermally-driven processes such as MSF and MED is replaced by small holes in microporous membranes. Hence, MD combines the advantages of both conventional distillation and membrane distillation methods, such as compact in facility, low operation pressure and temperature, almost 100% salt rejection, tolerance of high salinity, reduced chemical interaction between the membrane and process solution, and less demanding on the membrane's mechanical strength, etc. The most attractive feature of MD is that it can operate at temperatures lower than the boiling point of water, so that the MD process can be coupled with low-grade heat resources such as solar energy. Economic feasibility studies predict that such integrations can potentially reduce the overall desalination cost to a cost lower than that of the existing technologies.^{[3,6,7]}

MD systems can be used in many configurations depending on how liquid is collected from the permeate side, as shown in FIG. 1 (types of membrane distillation: A) DCMD, B) AGMD, C) VMD, D) SGMD). In direct contact MD (DCMD), the vapor is condensed on a pure water stream that contacts the other side of the membrane. In air gap MD (AGMD), an air gap separates the membrane from a cold condensing plate which collects vapor that moves across the gap. In vacuum MD (VMD), the permeate side is kept at lower pressure to enhance the pressure difference across the membrane, and condensation may occur in the module, or in an external condenser. In sweeping gas MD (SGMD), a carrier gas is used to remove the vapor, which is condensed in a separate component. All the different configurations of MD can be applied to seawater and brackish water desalination; however, the most common ones for desalination are DCMD, AGMD, and VMD.

The bright future of MD in seawater desalination has stimulated a broad interest among the membrane society. An abrupt increase in the number of publications was particularly observed in the last 6 years,^{[8]} which is probably trigged by the increase in oil price which makes the usage of sustainable energy a foremost urgent task. However, large-scale application of MD in seawater desalination has been hindered by the performance of existing membranes. Almost all the MD studies were based on the following three polymeric membranes: polyvinylidene fluoride (PVDF), polytetrafluoroethylene (PTFE), and polypropylene (PP). These membranes have the following drawbacks.
(1) The water flux is low. To the best of our knowledge, the highest flux report so far is no more than 80 kg/m²·h at operational temperatures below the boiling point of water. The water fluxes obtained from the real pilot-scale MD units are even lower, typically less than 5 kg/m²·h.^{[9-12]}
(2) The energy cost is high. Depending on the operational conditions, the energy consumption reported from the current MD units ranges from 100 to few thousands kWh/m³,^{[10-12]} which is much higher than the energy cost listed in Table 1.
(3) The long-term stability, particularly the “wetting” issue, is a big problem. “Wetting” may be induced by salt deposit or by membrane degradation. To make the MD process economically feasible, a life time more than 10 years is expected, while current membrane modules are typically less than 3 years.

Among these drawbacks, increasing the membrane flux has the foremost priority.^{[3,13]} High membrane flux will increase water productivity and decrease energy cost. Preparation of high-flux membranes out of carbon nanotubes (CNTs) has attracted wide attention in recently years due to the discovery that the transport rate of water molecules through CNT channels is superfast because of their ultra-smooth surface.^{[2,14-18]} Most of the studies focused on development of composite membranes where CNTs were embedded in either inorganic or polymeric matrixes.^{[2,15,19-29]} However, this approach has a lot of technical barriers such as (1) how to uniformly disperse CNTs inside the matrix; (2) how to align CNTs along the diffusion pathway; (3) how to eliminate boundary effects between CNTs and the matrix; and (4) the density of CNTs is generally low. Overall, such a mixed matrix membrane approach has achieved only limited success in flux enhancement.

One technology uses nanotubes attached (aligned horizontally in the support) to a support using a polymer, such as polyvinylidene fluoride, where the nanotubes are included to enhance properties of the polymer membrane. However, this technology has a very low salt rejection rate at salt concentrations of 3.5% or more and a short lifetime, which hinders its practical use as a desalination technique for sea water. Thus, there is a need for a technique to overcome the deficiencies of the currently used desalination technologies.

### SUMMARY

In accordance with the purpose(s) of the present disclosure, as embodied and broadly described herein, embodiments of the present disclosure provide membranes, methods of making the membrane, systems including the membrane, methods of separation, methods of desalination, a separation system, and the like. Exemplary embodiments of the present disclosure can be advantageous in that it has a high salt rejection rate, improved water flux, and/or the lifetime of the membrane is longer than other reported membranes. Additional details are provided in the Detailed Description and the Examples.

In an embodiment, the membrane includes: a layer of nanostructures (e.g., nanotubes, nanowires, or a combination of nanotubes and nanowires) disposed on a substrate (which can be porous), where the nanostructures are disposed primarily vertically with respect to the surface of the substrate. The layer can include gaps between the nanostructures that allow permeation of vapor and gases. In an embodiment, the nanostructures can be carbon nanotubes such as: a single-wall carbon nanotube, a multi-wall carbon nanotube, and a combination thereof. In an embodiment, the substrate can be made of a material such as: metal (e.g., nickel, iron, titanium, cobalt, gold, silver, copper, metal alloys of these), ceramic (e.g., alumina, zirconia, titania), carbon, polymer, and a combination thereof.

In an embodiment, the method of making a membrane can include: providing a porous substrate; exposing the porous substrate to a carbon source; and heating the porous substrate with the carbon source to form a carbon nanostructure layer on the surfaces of the porous substrate. The porous substrate can be in the form of a flat sheet, tube, hollow fiber, or a monolith. The porous substrate can be made from a metal selected from the group consisting of: nickel metal powder, copper powder, iron powder, silver powder, gold powder, and a combination thereof. The porous substrate can be made from ceramics consisting of silica, alumina, zirconia, titania, or carbon, or a combination thereof. The carbon source can be a compound selected from the group consisting of: acetylene, methane, CO, and a combination thereof. The metal substrate can be reduced before it is exposed to the carbon source by heating the metal substrate at about 700° C. to 900° C. for about 3 to 7 hours under the flow of hydrogen to remove oxides on the surface. The ceramic or carbon substrate can be deposited with a layer of nanoparticles before it is exposed to the carbon source. The nanoparticles can be made of nickel, iron, cobalt, or a combination thereof. Heating the porous substrate with the carbon source to form a carbon nanotube layer can include heating at about 700° C. for about 2 minutes to 1 hour. The method can further include depositing the carbon nanostructure layer on one or both sides of the porous substrate.

In an embodiment, the method of making a membrane can include extruding a mixture including a metal powder (e.g., nickel powder) through a spinneret to form a metal porous hollow fiber. Next the metal porous hollow fiber is sintered (e.g., about 450 to 650° C.) to remove organic compounds. Subsequently, the metal of the metal porous hollow fiber is reduced by heating (e.g., about 700 to 900° C.) the metal porous hollow fiber under a reducing environment. Then, the nanostructure layer (e.g., a carbon nanotube layer) is formed on the metal porous hollow fiber by exposing the fiber to a carbon source (e.g., acetylene) and heating the metal porous hollow fiber to form a carbon nanotube layer on the surfaces of the metal porous hollow. In an embodiment, the nanostructure layer can be disposed on one or a combination of the outer surface of the metal porous hollow fiber, inner pore surfaces of the metal porous hollow fiber, and the inner surface of the metal porous hollow fiber.

In an embodiment, the method of separation includes exposing a first liquid (e.g., seawater, waste water, and the like) to a membrane having a layer of nanostructures (e.g., nanotubes and/or nanowires) disposed on a substrate, where the nanostructures are disposed vertically (vertically aligned) with respect to the surface of the substrate. The method can further include generating a vapor from interaction of the first liquid with the membrane and collecting a second liquid from condensation of the vapor. The first liquid can be a solution containing a more volatile component and a less volatile component. The second liquid can contain primarily the more volatile component. The first fluid can be heated, and a second liquid can be collected from the other side of the membrane. In an embodiment, the method of separation can include a method of desalination when the first liquid is seawater or waste water. In an embodiment, about 99% or more of the salt is removed when the second liquid (for example, desalinated water) is compared to the first liquid (for example, seawater).

In an embodiment, the separation system includes a membrane having a layer of nanostructures (e.g., nanotubes and/or nanowires) disposed on a substrate, where the nanostructures are disposed vertically with respect to the surface of the substrate. In an embodiment, the distillation desalination system includes a membrane having a layer of nanostructures disposed on a substrate, where the nanostructures are disposed vertically with respect to the surface of the substrate. In an embodiment, the separation system (for example, a distillation desalination system) can be operated in a mode selected from: an air gap membrane distillation (AGMD), a direct contact membrane distillation (DCMD), a vacuum membrane distillation (VMD) or a sweeping gas membrane distillation (SGMD) mode. In an embodiment, the separation system and/or the distillation desalination system can include a solar system adapted to provide heat to the system.

In any one or more of the foregoing embodiments, the nanotubes can be super hydrophobic. The nanotubes can be carbon nanotubes. The carbon nanotubes can be selected from the group consisting of: a single-wall carbon nanotube, a multi-wall carbon nanotube, and a combination thereof. The layer of nanotubes can contain gaps between nanotubes of about 10 nm to 10 μm. The layer of nanotubes can be formed on the pores of the substrate. The layer of nanostructures can cover one side or both sides of the substrate. The layer of nanotubes can have a thickness of about 10 nm to 10 μm. The substrate can be in the form of a flat sheet, tube, hollow fiber, or monolith. The substrate can be made of a material selected from the group consisting of: nickel, iron, titanium, cobalt, gold, silver, copper, metal alloys of these, and a combination thereof. The substrate can be made of a material selected from the group consisting of: alumina, zirconia, titania, and a combination thereof. The substrate can be made of a polymer, carbon, and a combination thereof.

Other systems, methods, features, and advantages will be, or become, apparent to one with skill in the art upon examination of the following drawings and detailed description. It is intended that all such additional structures, systems, methods, features, and advantages be included within this description, be within the scope of the present disclosure, and be protected by the accompanying claims.

### BRIEF DESCRIPTION OF THE DRAWINGS

Many aspects of this disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 illustrates different types of membrane distillation systems: A) DCMD, B) AGMD, C) VMD, and D) SGMD.

FIG. 2 illustrates SEM images of (A) outer surface and (B) cross-section of a nickel hollow fiber after sintering.

FIG. 3 illustrates a schematic diagram of a catalytic CVD apparatus setup.

FIG. 4 illustrates a photograph (A) and outer surface SEM image (B) of a CNT/Ni hollow fiber membrane.

FIG. 5 illustrates an embodiment of a set-up for a water desalination experiment.

FIG. 6A shows the water flux at different temperatures on a membrane fabricated at the CVD growth time of 10 minutes.

FIG. 6B shows the water flux measured at 60° C. from membranes fabricated at different CVD growth times.

FIG. 7A shows the permeance of different gases plotted as a function of trans-membrane pressure drop.

FIG. 7B shows the permeance at the pressure drop of 0.7 bar plotted as a function of the inverse square root of molecular weight.

### DETAILED DESCRIPTION

This disclosure is not limited to particular embodiments described, and as such may, of course, vary. The terminology used herein serves the purpose of describing particular embodiments only, and is not intended to be limiting, since the scope of the present disclosure will be limited only by the appended claims.

Where a range of values is provided, each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Embodiments of the present disclosure will employ, unless otherwise indicated, techniques of material science, chemistry, and the like, which are within the skill of the art. Such techniques are explained fully in the literature.

The following examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, reagents, reaction materials, manufacturing processes, dimensions, frequency ranges, applications, or the like, as such can vary. It is also to be understood that the terminology used herein is for purposes of describing particular embodiments only, and is not intended to be limiting. It is also possible in the present disclosure that steps can be executed in different sequence, where this is logically possible. It is also possible that the embodiments of the present disclosure can be applied to additional embodiments involving measurements beyond the examples described herein, which are not intended to be limiting. It is furthermore possible that the embodiments of the present disclosure can be combined or integrated with other measurement techniques beyond the examples described herein, which are not intended to be limiting.

It should be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

Each of the applications and patents cited in this text, as well as each document or reference cited in each of the applications and patents (including during the prosecution of each issued patent; “application cited documents”), and each of the PCT and foreign applications or patents corresponding to and/or claiming priority from any of these applications and patents, and each of the documents cited or referenced in each of the application cited documents, are hereby expressly incorporated herein by reference. Further, documents or references cited in this text, in a Reference List before the claims, or in the text itself; and each of these documents or references (“herein cited references”), as well as each document or reference cited in each of the herein-cited references (including any manufacturer's specifications, instructions, etc.) are hereby expressly incorporated herein by reference.

Prior to describing the various embodiments, the following definitions are provided and should be used unless otherwise indicated.

### DISCUSSION

Embodiments of the present disclosure provide for membranes, systems including the membrane, methods of making the membrane, methods of separation, methods of desalination, and the like. In an embodiment, the membrane uses the super hydrophobicity property and high stability of the nanostructure (e.g., carbon nanotubes) to achieve outstanding results that are superior to presently used techniques.

In general, embodiments of the membrane can be used in processes and systems in the water, food, and pharmaceutical areas. In an embodiment, the membrane can be used in a separation system to separate components in a first fluid. In an embodiment, the membrane can be used in desalination of a liquid and/or to separate a solvent from a liquid including the solvent. Exemplary embodiments of the present disclosure can be advantageous in that it has a high salt rejection rate (e.g., greater than about 99% at a salt concentration of about 5%), improved water flux (e.g., at least 100% better than other reported water fluxes), and/or the lifetime of the membrane is longer than other reported membranes. Additional details are provided in the Example.

In an embodiment, the membrane can be made using the following method. In an embodiment, a mixture including a metal powder (e.g., nickel powder) can be extruded through a structure (e.g., spinneret) to form a metal porous hollow fiber. In an embodiment, the mixture is formed by ball milling the components of the mixture to mix and disperse the components. In an embodiment, the mixture can be degassed under a vacuum. In an embodiment, the mixture can be extruded using a spinneret, where water can be used as the inner and outer coagulant.

In an embodiment, the metal powder can include a metal powder such as a nickel metal powder, copper metal powder, gold metal powder, silver metal powder, and the like. In an embodiment, the mixture can include a metal powder and one or more other components (e.g., solvent, polymer, surfactant, or a combination thereof). In particular, the mixture can include nickel metal powder, 1-methyl-2-pyrrolidinone, polyether sulfone, and polymeric surfactant. Additional details are provided in the Example.

Next the metal porous hollow fiber can be dried (e.g., at room temperature) and heated to remove any residual organic compounds. In an embodiment, the metal porous hollow fiber can be heated to about 450 to 650° C. or about 550° C. for about 3 to 7 h or about 5 h, under a flow of gas (e.g., air) to remove the residual organic compounds.

Once the residual organic compounds are removed and the metal porous hollow fiber is cooled down, the metal porous hollow fiber can be heated to reduce the metal. In an embodiment, the metal porous hollow metal can be heated to about 700 to 900° C. or about 800° C. for about 3 to 7 h or about 5 h, in a gas (e.g., hydrogen).

In an embodiment, the metal porous hollow fiber can include voids in micrometer scales through the hollow fiber, which are favorable for diffusion of vapor across the metal porous hollow fiber via the voids (or pores). In addition, the metal porous hollow fiber can have a high mechanical strength and high porosity.

In an embodiment, the metal porous hollow fiber has an outer diameter of about 0.5 mm to 1.5 mm or about 0.9 mm. In an embodiment, the metal porous hollow fiber has an inner diameter of about 0.6 to 1.4 mm or about 0.8 mm. In an embodiment, the metal porous hollow fiber has void (pores) having a diameter of about 1 to 3 μm.

Subsequently, the metal porous hollow fiber is exposed to a nanostructure source (e.g., carbon source) and then the metal porous hollow fiber can be heated with the carbon source, for example, to form a nanostructure (e.g., a nanotube and/or nanowire such as a carbon nanotube and/or nanowire layer) layer on one or more surfaces of the metal porous hollow. In an embodiment, the metal porous hollow fiber can be heated in one or more carrier or forming gases (e.g., argon and hydrogen) and reducing gas (e.g., hydrogen) at about 700° C. Then the metal porous hollow fiber can be heated with the carbon source heating at about 700° C. for about 2 min to 1 hour, in carrier or forming gases and reducing gas. Subsequently, the metal porous hollow fiber including the nanotube layer can be cooled.

In an embodiment, the carbon source can be a compound selected from acetylene, methane, CO, and a combination thereof. In an embodiment, the amount of the carbon source used can depend upon the desired characteristics (e.g., thickness, dimensions of the nanotubes, diameter (e.g., inner and/or outer), and the like) of the carbon nanostructure (e.g., nanotube and/or nanowire) layer to be formed on the metal porous hollow fiber. In an embodiment, the carbon nanostructure layer can be disposed on one or more of the following: outer surface of the metal porous hollow fiber, inner pore surfaces of the metal porous hollow fiber, the inner surface of the metal porous hollow fiber, or a combination of one or more of these.

In an exemplary embodiment and as mentioned above, the membrane includes a layer of nanostructures disposed on a substrate (e.g., porous nickel hollow fiber or tube). In an embodiment, the layer of nanostructures can include nanotubes, nanowires, or a combination of nanotubes and nanowires.

In an embodiment, the substrate can be made of a material such as a metal or metal alloy, a ceramic, carbon, or a polymer. In an embodiment, the metal can include nickel, iron, titanium, cobalt, gold, silver, copper, metal alloys of these, and a combination thereof. In an embodiment, the ceramic can include alumina, zirconia, titania, and a combination thereof. In an embodiment, the polymer can include polyvinylidene fluoride (PVDF), polytetrafluoroethylene (PTFE), and polypropylene (PP), polyacrylonitrile, and a combination thereof.

In an exemplary embodiment, the substrate can be a flat sheet, tube (hollow or solid), hollow fiber, and monolith (a one piece structure), and the like. In an embodiment, the substrate is porous. In an embodiment, the pores in the substrate can be about 500 nm to 10 μm across, where the pores extend through the substrate or through a wall of the substrate if the substrate is hollow.

In an embodiment, the metal porous hollow fiber has an outer diameter of about 0.5 mm to 1.5 mm or about 0.9 mm. In an embodiment, the metal porous hollow fiber has an inner diameter of about 0.6 to 1.4 mm or about 0.8 mm. In an embodiment, the metal porous hollow fiber has pores having a diameter of about 1 to 10 μm. In an embodiment, the length of the substrate can be selected as needed for particular applications.

In an embodiment, the layer of nanostructures can be continuous or can include a plurality of discrete areas of nanostructures on the substrate (e.g., porous nickel tube). In an embodiment, nanostructures in the nanostructure layer can have gaps or spaces between them of about 10 nm to 5 μm. In an embodiment, the nanostructures can be disposed (e.g., formed, grown, etc.) vertical (e.g., primarily vertical (e.g., about 60% or more, about 75% or more, or about 60% to 100% or about 75% to 100%), substantially vertical (e.g., about 90% or more, or about 90 to 100%), and/or completely vertical (e.g., about 99% or more, about 100%), since there can be variations among the nanostructures) or parallel relative to the surface of the substrate as opposed to being disposed perpendicular to the surface of the substrate.

In an embodiment, the nanoparticles can be carbon nanoparticles, boron nitride nanoparticles, or polymer nanoparticles. In an embodiment, the nanotubes can be carbon nanotubes, boron nitride nanotubes, or polymer nanotubes. In an embodiment, the carbon nanotubes can include single-wall carbon nanotubes or multi-wall carbon nanotubes.

In an embodiment, the diameter of the nanostructure can be about 0.5 to 100 nm and the length can be about 50 nm to 5000 nm. In an embodiment, the diameter of the nanotube can be about 0.5 to 100 nm or about 0.5 to 8 nm and the length can be about 50 nm to 5000 nm. In an embodiment, the diameter of the nanowire can be about 0.5 to 100 nm or about 0.5 to 8 nm and the length can be about 50 nm to 5000 nm.

In an embodiment, the functional surface of the substrate can include the layer of nanostructures, while in other embodiments only a portion (e.g., about 10 to 90% of the function surface) of the functional surface of the substrate includes the layer of nanostructures. The phrase “functional surface” includes the surface that is included in the desired process and/or reaction (e.g., in contact with sea water). For example, only a portion of the membrane may be disposed in a liquid while another portion is not disposed in the liquid. It is contemplated that a portion of the substrate not involved in the process and/or reaction may not include the layer of nanostructures.

In an exemplary embodiment, a method of separation includes exposing a first liquid to a membrane, where the membrane is part of a separation system. In an embodiment, the first liquid can be water including one or more components (e.g., salt, organic solvents, pharmaceutical compounds, biological compounds, and other contaminants) at various concentration levels. In an embodiment, the first liquid is heated to a temperature of about 40 to 99° C. The heated first liquid interacts with the membrane and a vapor is generated in the lumen of the membrane. In an embodiment, the vapor flows through the hollow portion of the substrate and can be cooled in a condenser and collected in a container (e.g., a container disposed in liquid nitrogen). The vapor is condensed to form a second liquid that has a reduced component content relative to the first liquid. For example, the salt content of a first liquid can be reduced using this method, where the second liquid has the reduced salt content. In another embodiment, the second liquid includes (e.g., greater than about 90%, greater than about 95%, greater than about 99%, greater than about 99.9%, or 100%) the more volatile component. In an embodiment, the method can be conducted in a vacuum membrane distillation set up.

In an exemplary embodiment, a method of desalination includes exposing a first liquid to a membrane, where the membrane is part of a desalination system. In an embodiment, the carbon nanotubes are super hydrophobic and super stable, so the first liquid can include sea water or waste water. In an embodiment, the first liquid can include about 0.1% to 5% of salt. In an embodiment, the first liquid is heated to a temperature of about 40 to 90° C. The heated first liquid interacts with the membrane and a vapor is generated in the lumen of the membrane. In an embodiment, the vapor flows through the hollow portion of the substrate and can be collected in a condenser and collected in a container (e.g., a container disposed in liquid nitrogen). The vapor is condensed to form a second liquid that has a reduced salt content relative to the first liquid. In an embodiment, the second liquid has about 99% or more, about 99.5% or more, or about 99.8% or more, of the salt removed when compared to the first liquid at a salt concentration of about 0.01 to 10% or about 5%. It should be noted that the amount of salt removed can change (e.g., increase) at a salt concentration of less than about 5%. In an embodiment, the method can be conducted in a vacuum membrane distillation set up. Additional details are provided in the Example, which describes a desalination process of a 5% NaCl solution.

In an embodiment, the method has an improved water flux (e.g., at least 100% or more) relative to other reported water fluxes. In an embodiment, the water flux can be up to about 160 L/m², about 80 to 160 L/m², or about 85 to 160 L/m².

In an embodiment, the lifetime of the membrane is longer than other reported membranes. In an embodiment, the membrane lifetime is about 1 to 20 years or 10 years or more.

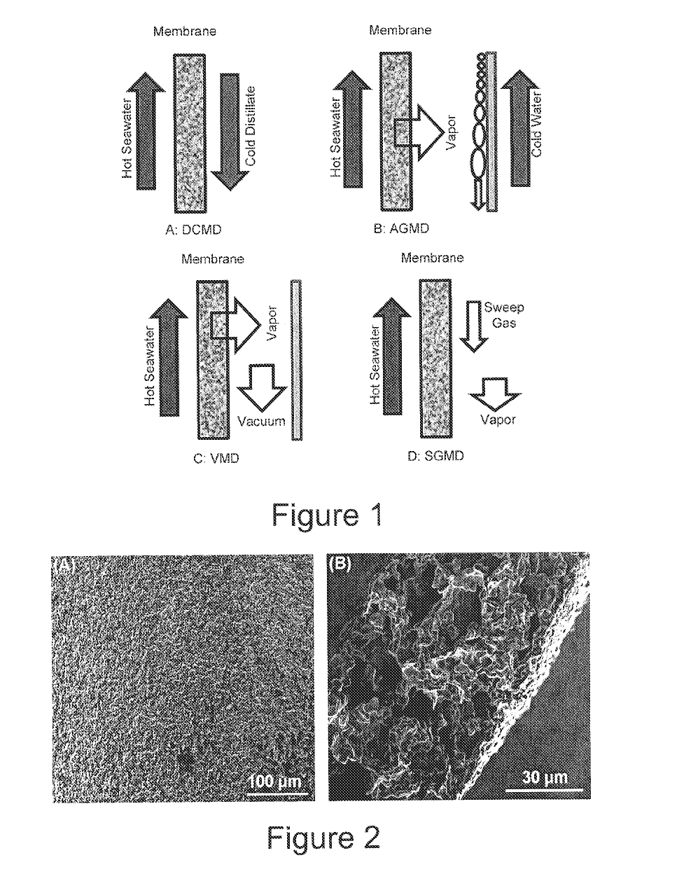

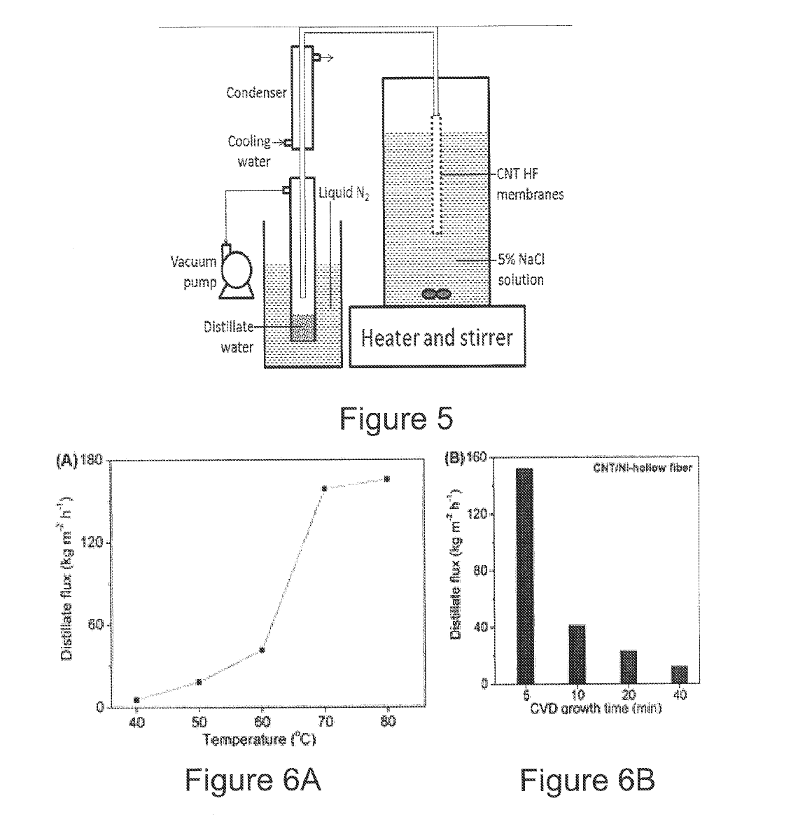

In an embodiment, the method of desalination can be implemented in a system (e.g., FIG. 5) that can be operated in an AGMD, DCMD, VMD or SGMD mode, such as those described in FIG. 1 and described in the corresponding text. In this regard, the membrane of the present disclosure can be used as the membrane in these systems. In addition, the system can be coupled with a system that collects solar energy, where the energy can be used to increase the temperature of the liquid (e.g., first liquid), which reduces cost significantly.

In an exemplary embodiment, a method of separating a solvent from a first liquid can include exposing a first liquid to a membrane. In an embodiment, the first liquid can include a solvent such as methanol, ethanol, propanol, or a combination thereof. In an embodiment, the first liquid can include about 1% to 99% of solvent. In an embodiment, the first liquid is heated to a temperature of about 40 to 100° C. The heated first liquid interacts with the membrane and a vapor is generated. In an embodiment, the vapor flows through the hollow portion of the substrate and can be collected. The vapor is condensed to form a second liquid (the solvent or solvent mixture) that has been removed from the first liquid.

### EXAMPLES

### Example 1

### Fabrication of a Carbon Nanotube Layer on a Nickel Hollow Fiber

Hollow nickel fibers with inner and outer diameters of 0.83 and 0.90 mm, respectively, were fabricated through a combined phase-inversion/sintering method.^{[32]} Nickel powder (1 μm, Acupowder International, LLC), 1-methyl-2-pyrrolidinone (NMP, HPLC grade, 99.5%, Alfa Asea), Polyether Sulfone (PES, Ultrason® E6020P, BASF) and Zephrym PD 3315 (CRODA) were mixed and well dispersed by ball milling for 18 h in argon atmosphere, followed by degassing under vacuum for 24 h. After that, the suspension was extruded through a spinneret using water as the inner and outer coagulant. The green body of the hollow fiber was dried at room temperature and then sintered at 550° C. for 5 h to remove organic compounds in air flow of 500 mL min⁻¹. After being cooled down to room temperature, the fiber was reduced at 800° C. for 5 h in pure hydrogen of 500 mL min⁻¹. FIG. 2 illustrates SEM images of (A) outer surface and (B) cross-section of a nickel hollow fiber after sintering. In particular, FIG. 2 shows the outer surface and cross-section of a sintered porous nickel hollow fiber. The bare hollow fiber has high mechanical strength together with high porosity. The average pore size on the outer skin of nickel hollow fiber is in the range of 1-3 μm (FIG. 2A). The wall of the hollow fiber (FIG. 2B) contains microvoids, which is favorable for the diffusion of vapor across the membrane.

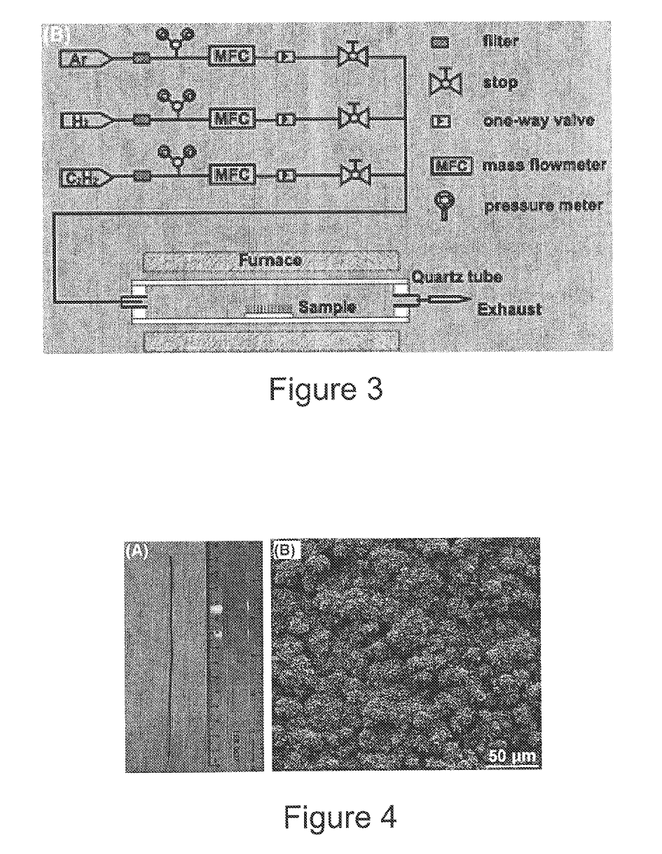

A catalytic CVD method was used to grow a layer of carbon nanotubes on the surface of nickel hollow fibers.^{[33-35]} A schematic diagram of a catalytic CVD apparatus setup is shown in FIG. 3. During the CVD process, argon was used as the carrier gas, hydrogen as the reduction and carrier gas, and acetylene as the carbon source. After evacuation of the CVD chamber (quartz tube), the reduced nickel hollow fiber was heated to 700° C. in the forming gas (H₂/Ar, 200/200 ml min⁻¹) and then the hollow fiber was exposed to C₂H₂ (50 mL min⁻¹) at 700° C. for different growth time (40, 20, 10, 5 min), followed by cooling in argon (500 mL min⁻¹).

A photograph of an as-prepared carbon nanotube membrane grown on nickel hollow fiber (CNT/Ni-HF) is shown in FIG. 4A. In particular, FIG. 4 illustrates a photograph (A) and outer surface SEM image (B) of a CNT/Ni-HF membrane. The membrane shows a uniform black appearance. It can be seen that carbon nanotubes were successfully grown on the nickel hollow fiber surface. As the size of nickel particles is much bigger than the diameter of carbon nanotubes, hence on each nickel particle many carbon nanotubes grown along the outward directions can be identified.

### Example 2

### Seawater Desalination Performance of CNT/Ni-HF Membranes

The water desalination experiment was performed using a setup schematically shown in FIG. 5. A 5% NaCl solution was used as synthetic seawater with salinity higher than the Red Sea. The solution was well-mixed by a stir bar, and the temperature was controlled by a heater. CNT/Ni-hollow fibers shown in FIG. 4A were mounted in a stainless steel adaptor. The shell side of the fiber was in contact with the hot salt solution, and the lumen side was connected to a vacuum pump to withdraw the permeated vapor. The vapor was condensed first by a cooling water condenser followed by a liquid nitrogen jar. The whole setup is equivalent to a vacuum membrane distillation (VMD) process. The amount of collected water was weighed with an electronic balance (Mettler Toledo) at regular time intervals. The conductivity of the salt solution and the collected water was measured by a conductivity meter (equipped with Mettler Toledo Inlab® 710 electrode). The NaCl rejection R was calculated by the equation:

$$R = \frac{{C}_{F} - {C}_{P}}{{C}_{F}} \times 100$$

where C_{F} and C_{P} are the conductivities of the salt solution and the permeate water, respectively.

It was found that the CNT/Ni-HF membrane could effectively desalinate concentrated salt solution. The conductivity of the 5 wt. % NaCl solution is about 96700 μs/cm, while the conductivity of the distilled water is below 150 μS/cm in all situations, which implies that the salt rejection rate is over 99.8%. FIG. 6A shows the water flux at different temperatures on a membrane fabricated at the CVD growth time of 10 minutes. In all cases, the salt solution contains 5 wt. % NaCl with a conductivity of 96700 μS/cm, and the conductivity of the distilled water is below 150 μS/cm. The water flux increased sharply when the temperature rose from 40 to 70° C., which reflected the exponential dependency of the saturated vapor pressure with temperature. The water flux was flattened after 70° C. This is probably due to the temperature polarization effect. Nevertheless, the water flux achieved at 70° C. or 80° C. are almost twice of the highest value reported from polymeric membranes. The water flux was found dependent on the fabrication conditions. FIG. 6B shows the water flux measured at 60° C. from membranes fabricated at different CVD growth time. A significant increase in water flux was observed when the CVD growth time decreased from 10 to 5 minutes. The result implies that there's a plenty of room for further flux improvement in future optimization of the membrane fabrication conditions.

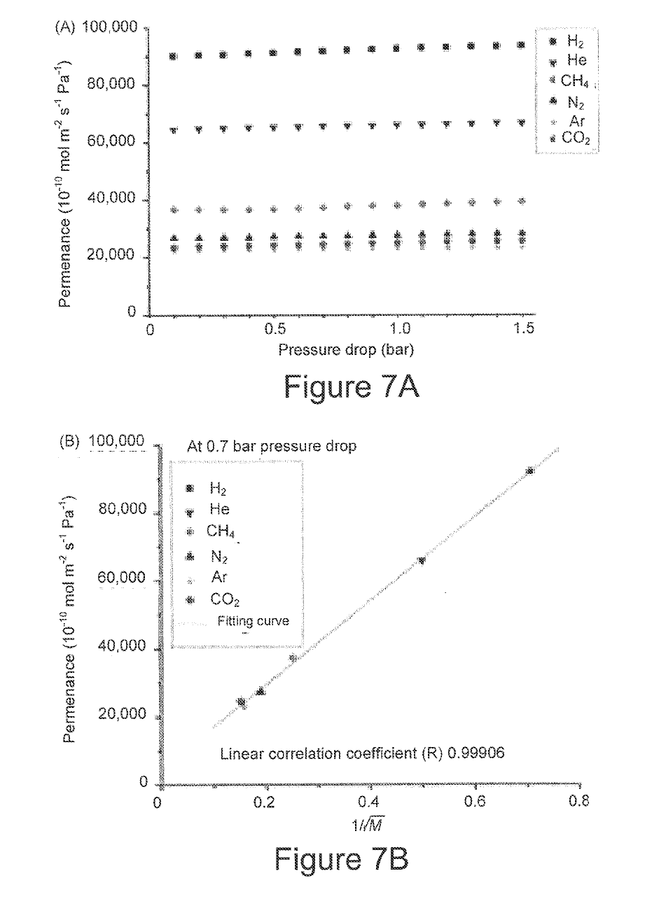

The CNT/Ni-HF membrane fabricated at the CVD growth time of 10 minutes was further characterized by single-gas permeation studies at room temperature. FIG. 7 shows room temperature single-gas permeation studies over the CNT/Ni-HF membrane fabricated at the CVD growth time of 10 minutes. FIG. 7(A) shows the permeance of different gases plotted as a function of trans-membrane pressure drop; while FIG. 7(B) shows the permeance at the pressure drop of 0.7 bar plotted as a function of the inverse square root of molecular weight. In all cases the permeance remained almost constant with increased pressure drop, indicating that the viscous flow across the membrane is negligible. Data points in FIG. 7A can be fitted with the Tsai-Yasuda equation to calculate the mean pore size of the carbon nanotube membrane.^{[36]} The obtained value is around 37 nm. FIG. 7B shows at the trans-membrane pressure drop of 0.7 bar, which is equivalent to the pressure difference at the distillation temperature of 90° C., the gas permeance plotted as a function of the inverse square root of molecular weight. A straight line can well fit all the data points in FIG. 7B, indicating that the gas transport through the CNT/Ni-HF membrane mainly follows the Knudsen diffusion mechanism.

### REFERENCES, EACH OF WHICH IS INCORPORATED HEREIN BY REFERENCE

[1] Elimelech, M.; Phillip, W. A., Science, 2011, 333, 712-717.
[2] Shannon, M. A.; Bohn, P. W.; Elimelech, M.; Georgiadis, J. G.; Marinas, B. J.; Mayes, A. M., Nature, 2008, 452, 301-309.
[3] Ghaffour, N.; Missimer, T. M.; Amy, G. L., Desalination, 2013, 309, 197-207.
[4] Fiorenza, G.; Sharma, V. K.; Braccio, G., Energy Conversion and Management, 2003, 44, 2217-2240.
[5] Khayet, M.; Matsuura, T. Membrane distillation: principles and applications; Elsevier: Amsterdam, The Netherlands, 2011.
[6] Al-Obaidani, S.; Curcio, E.; Macedonio, F.; Profio, G. D.; Al-Hindai, H.; Drioli, E., J. Membr. Sci., 2008, 323, 85-98.
[7] Hanemaaijer, J. H.; van Medevoort, J.; Jansen, A. E.; Dotremont, C.; van Sonsbeek, E.; Yuan, T.; Ryck, L. D., Desalination, 2006, 199, 175-176.
[8] Khayet, M., Advances in Colloid and Interface Science, 2011, 164, 56-88.
[9] Guillen-Burrieza, E.; Blanco, J.; Zaragza, G.; Alarcon, D. C.; Palenzuela, P.; Ibarra, M.; Gernjak, W., J. Membr. Sci., 2011, 379, 386-396.
[10] Banat, F.; Jwaied, N.; Rommel, M.; Koschikowski, J.; Wieghaus, M., Desalination, 2007, 217, 17-28.
[11] Winter, D.; Koschikowski, J.; Wieghaus, M., J. Membr. Sci., 2011, 375, 104-112.
[12] Guillen-Burrieza, E.; Zaragza, G.; Miralles-Cuevas, S.; Blanco, J., J. Membr. Sci., 2012, 409-410, 264-275.
[13] Cabassud, C.; Wirth, D., Desalination, 2003, 157, 307-314.
[14] Skoulidas, A. I.; Ackerman, D. M.; Johnson, J. K.; Sholl, D. S., PRL, 2002, 89, 185901.
[15] Hinds, B. J.; Chopra, N.; Rantell, T.; Andrews, R.; Gavalas, V.; Bachas, L. G., Science, 2004, 303, 62-65.
[16] Holt, J. K.; Park, H. G.; Wang, Y. M.; Stadermann, M.; Artyukhin, A. B.; Grigoropoulos, C. P.; Noy, A.; Bakajin, O., Science, 2006, 312, 1034-1037.
[17] Verweij, H.; Schillo, M. C.; Li, J., Small, 2007, 3, 1996-2004.
[18] Aluru, N. R.; Joseph, S., Nano. Letters, 2008, 8, 452-458.
[19] Sholl, D. S.; Johnson, J. K., Science, 2006, 312, 1003-1004.
[20] Corry, B., J. Phys. Chem. B, 2008, 112, 1427-1434.
[21] Gusev, A. A.; Guseva, O., Adv. Mater., 2007, 19, 2672-2676.
[22] Mi, W. L.; Lin, Y. S.; Li, Y. D., J. Membr. Sci., 2007, 304, 1-7.
[23] Kim, S.; Chen, L.; Johnson, J. K.; Marand, E., J. Membr. Sci., 2007, 294, 147-158.
[24] Veerapaneni, S.; Long, B.; Freeman, S.; Bond, R., J. Am. Water Works Assoc., 2007, 99, 95-106.
[25] Kim, S.; Jinschek, J. R.; Chen, H.; Sholl, D. S.; Marand, E., Nano Letters, 2007, 7, 2806-2811.
[26] Kim, B.; Sigmund, W. M., Colloids and Surfaces A: Physicochem. Eng. Aspects, 2005, 266, 91-96.
[27] Tian, Y.; Park, J. G.; Cheng, Q. F.; Liang, Z. Y.; Zhang, C.; Wang, B., Nanotechnology, 2009, 20, 335601.
[28] Olivier, C.; Moreau, C.; Bertoncini, P.; Bizot, H.; Chauvet, O.; Cathala, B., Langmuir, 2012, 28, 12463-12471.
[29] Ratto, T. V.; Holt, J. K.; Szmodis, W., “Membranes with embedded nanotubes for selective permeability”, U.S. Pat. No. 7,993,524 B2, 2011.
[30] Gethard, K.; Sae-Khow, O.; Mitra, S., ACS Appl. Mater. Interfaces, 2011, 3, 110-114.
[31] Mitra, S.; Gethard, K., “Membrane distillation apparatus and methods”, US patent, 201110272354 A1, 2011.
[32] Lee, S. M.; Choi, I. H.; Myung, S. W.; Park, J. Y.; Kim, I. C.; Kim, W. N.; Lee, K. H., Desalination, 2008, 233, 32-39.
[33] Reddy, N. K.; Meunier, J. L.; Coulombe, S., Mater. Letters, 2006, 60, 3761-3765.
[34] Chen, B.; Wu, P., Carbon, 2005, 43, 3172-3177.
[35] Deng, F. M.; Chen, X. H.; Zhao, G. G.; Wang, Z. T.; Lu, X. L.; Li, W. Z., J. Mater. Sci., 2005, 40, 999-1003.
[36] Yasuda, H.; Tsai, J. T., J. Appl. Polym. Sci., 1974, 18, 805-819.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, the term “about” can include traditional rounding according to the measuring technique and the numerical value. In addition, the phrase “about ‘x’ to ‘y’” includes “about ‘x’ to about ‘y’”.

While only a few embodiments of the present disclosure have been shown and described herein, it will become apparent to those skilled in the art that various modifications and changes can be made in the present disclosure without departing from the spirit and scope of the present disclosure. All such modification and changes coming within the scope of the appended claims are intended to be carried out thereby.

1. A membrane, comprising:
a layer of nanostructures disposed on a porous substrate, wherein the nanostructures are disposed primarily vertically with respect to the substrate, and wherein the layer includes gaps between the nanostructures that allow permeation of vapor and gases.

2. The membrane of claim 1, wherein the nanostructures are selected from the group consisting of: nanotubes and nanowires and combinations thereof.

3. The membrane of claim 2, wherein the nanotubes are super hydrophobic.

4. The membrane of claim 2, wherein the nanotubes are carbon nanotubes.

5. The membrane of claim 4, wherein the carbon nanotubes are selected from the group consisting of: a single-wall carbon nanotube, a multi-wall carbon nanotube, and a combination thereof.

6. (canceled)

7. The membrane of claim 5, wherein the layer of nanotubes are formed on the pores of the substrate.

8. (canceled)

9. The membrane of claim 2, wherein the layer of nanotubes has a thickness of about 10 nm to 10 μm.

10. (canceled)

11. The membrane of claim 1, wherein the substrate is made of a material selected from the group consisting of: nickel, iron, titanium, cobalt, gold, silver, copper, metal alloys of these, and a combination thereof.

12. The membrane of claim 1, wherein the substrate is made of a material selected from the group consisting of: alumina, zirconia, titania, and a combination thereof.

13. The membrane of claim 1, wherein the substrate is made of a polymer, carbon, and a combination thereof.

14. A method of making a membrane, comprising:
providing a porous substrate;
exposing the porous substrate to a carbon source; and
heating the porous substrate with the carbon source to form a carbon nanostructure layer on the surfaces of the porous substrate.

15. (canceled)

16. The method of claim 14, wherein the porous substrate is made from a metal selected from the group consisting of: nickel metal powder, copper powder, iron powder, silver powder, gold powder, and a combination thereof.

17. The method of claim 14, wherein the porous substrate is made from ceramics consisting of silica, alumina, zirconia, titania, or carbon, or a combination thereof.

18. The method of claim 14, wherein the carbon source is a compound selected from the group consisting of: acetylene, methane, CO, and a combination thereof.

19. The method of claim 16, wherein the metal substrate is reduced before it is exposed to the carbon source by heating the metal substrate at about 700 to 900° C. for about 3 to 7 h under the flow of hydrogen to remove oxides on the surface.

20. The method of claim 17, wherein the porous substrate is deposited with a layer of nanoparticles before it is exposed to the carbon source.

21. The method of claim 20, wherein the nanoparticles are made of nickel, iron, cobalt, or a combination thereof.

22. The method of claim 14, wherein heating the porous substrate with the carbon source to form a carbon nanotube layer includes heating at about 700° C. for about 2 min to 1 hour.

23. (canceled)

24. A method of desalination, comprising:
exposing a first liquid to a membrane having a layer of nanostructures disposed on a porous substrate, wherein the nanostructures are disposed primarily vertically with respect to the substrate;
generating a vapor from interaction of the first liquid with the membrane; and
collecting a second liquid from condensation of the vapor.

25-28. (canceled)

29. A method of separation, comprising:
exposing a first liquid to a membrane having a layer of nanostructures disposed on a porous substrate, wherein the nanostructures are disposed primarily vertically with respect of the substrate;
generating a vapor from interaction of the first liquid with the membrane; and
collecting a second liquid from condensation of the vapor.

30-34. (canceled)
